(19) United States
(12) Patent Application Publication
(10) Pub. No.: US 2021/0291459 A1
(43) Pub. Date: Sep. 23, 2021

(54) THREE-DIMENSIONAL SHAPING APPARATUS AND THREE-DIMENSIONAL SHAPED ARTICLE PRODUCTION METHOD

(71) Applicant: SEIKO EPSON CORPORATION, Tokyo (JP)

(72) Inventor: Shigeru YAMAZAKI, SHIOJIRI-SHI (JP)

(21) Appl. No.: 17/206,449

(22) Filed: Mar. 19, 2021

(30) Foreign Application Priority Data
Mar. 23, 2020 (JP) 2020-051225

(51) Int. Cl. B29C 64/393; B29C 64/209; B29C 64/118; B33Y 10/00; B33Y 30/00; B33Y 50/02

(52) U.S. Cl. CPC B29C 64/393; B29C 64/209; B33Y 50/02; B33Y 10/00; B33Y 30/00; B29C 64/118

(57) ABSTRACT

A three-dimensional shaping apparatus includes a table at which a stacked body is shaped, a nozzle that ejects a shaping material, a sensor including at least one of a first sensor that detects a temperature of the shaping material ejected from the nozzle and a second sensor that detects an ejection state of the shaping material ejected from the nozzle, and a control unit that executes a feedback process for controlling drive of the three-dimensional shaping apparatus based on a detection result of the sensor, wherein the control unit executes the feedback process under first control when a first portion of the stacked body is shaped, executes the feedback process under second control when a second portion that is different from the first portion of the stacked body is shaped, and makes an execution frequency of the feedback process different between the first control and the second control.

The present application is based on, and claims priority from JP Application Serial Number 2020-051225, filed on Mar. 23, 2020, the disclosure of which is hereby incorporated by reference herein in its entirety.

### BACKGROUND

### 1. Technical Field

The present disclosure relates to a three-dimensional shaping apparatus and a three-dimensional shaped article production method.

### 2. Related Art

Heretofore, three-dimensional shaping apparatuses for shaping a stacked body by ejecting a shaping material from a nozzle toward a table thereby stacking layers have been used. Among these, in order to suppress a decrease in shaping accuracy of a three-dimensional shaped article, there is a three-dimensional shaping apparatus for shaping a three-dimensional shaped article while detecting various information regarding the three-dimensional shaped article during shaping with a sensor and performing feedback of the detection results. For example, JP-A-2019-51555 (Patent Document 1) discloses a welding robot that detects the temperature of a surface layer of bead weld layers stacked immediately before detection with a temperature sensor, and controls the shaping operation for a stacked structure based on the detection result of the temperature sensor.

However, by performing the feedback process, the shaping time for the three-dimensional shaped article becomes long. Depending on the shape of the three-dimensional shaped article to be shaped, a portion for which high shaping accuracy is not needed is sometimes included, however, in the three-dimensional shaping apparatus disclosed in Patent Document 1, even when such a three-dimensional shaped article is shaped, the shaping time becomes long. If the shaping time for the three-dimensional shaped article becomes long, the productivity of the three-dimensional shaped article decreases.

### SUMMARY

A three-dimensional shaping apparatus according to the present disclosure for solving the above problem is a three-dimensional shaping apparatus for shaping a stacked body by stacking layers using a shaping material, and includes a table at which the stacked body is shaped, a nozzle that ejects the shaping material, a sensor including at least one of a first sensor that detects a temperature of the shaping material ejected from the nozzle and a second sensor that detects an ejection state of the shaping material ejected from the nozzle, and a control unit that executes a feedback process for controlling drive of the three-dimensional shaping apparatus based on a detection result of the sensor, wherein the control unit executes the feedback process under first control when a first portion of the stacked body is shaped, executes the feedback process under second control when a second portion that is different from the first portion of the stacked body is shaped, and makes an execution frequency of the feedback process different between the first control and the second control.

Further, a three-dimensional shaped article production method according to the present disclosure for solving the above problem is a three-dimensional shaped article production method for shaping a stacked body using a three-dimensional shaping apparatus, and includes a detection step of detecting at least one of a temperature of an ejected shaping material and an ejection state of the ejected shaping material, and a feedback processing step of executing a feedback process for controlling drive of the three-dimensional shaping apparatus based on a detection result detected in the detection step, wherein in the feedback processing step, the feedback process is executed under first control when a first portion of the stacked body is shaped, the feedback process is executed under second control when a second portion that is different from the first portion of the stacked body is shaped, and an execution frequency of the feedback process is made different between the first control and the second control.

### BRIEF DESCRIPTION OF THE DRAWINGS

FIG. 1 is a schematic cross-sectional view showing a configuration of a three-dimensional shaping apparatus of one embodiment of the present disclosure.

FIG. 2 is a schematic perspective view showing a configuration of a flat screw in a three-dimensional shaping apparatus of one embodiment of the present disclosure.

FIG. 3 is a schematic plan view showing a configuration of a barrel in a three-dimensional shaping apparatus of one embodiment of the present disclosure.

FIG. 4 is a schematic cross-sectional view showing a configuration of a peripheral portion of a nozzle in a three-dimensional shaping apparatus of one embodiment of the present disclosure.

FIG. 5 is a schematic perspective view showing one example of a stacked body shaped using a three-dimensional shaping apparatus of one embodiment of the present disclosure.

FIG. 6 is a schematic perspective view showing a stacked body that is one example of a stacked body shaped using a three-dimensional shaping apparatus of one embodiment of the present disclosure, and is different from the stacked body in FIG. 5.

FIG. 7 is a schematic perspective view when viewing the stacked body in FIG. 6 from a different angle.

FIG. 8 is a schematic perspective view showing a stacked body that is one example of a stacked body shaped using a three-dimensional shaping apparatus of one embodiment of the present disclosure, and is different from the stacked body in FIG. 5 and the stacked body in FIG. 6.

FIG. 9 is a flowchart of one Example of a three-dimensional shaped article production method executed using a three-dimensional shaping apparatus of one embodiment of the present disclosure.

FIG. 10 is a flowchart of one Example of a three-dimensional shaped article production method executed using a three-dimensional shaping apparatus of one embodiment of the present disclosure, and is a flowchart of one Example of a three-dimensional shaped article production method that is different from the flowchart in FIG. 9.

FIG. 11 is a flowchart of one Example of a three-dimensional shaped article production method executed using a three-dimensional shaping apparatus of one embodiment of the present disclosure, and is a flowchart of one Example of a three-dimensional shaped article production method that is different from the flowcharts in FIGS. 9 and 10.

FIG. 12 is a flowchart of one Example of a three-dimensional shaped article production method executed using a three-dimensional shaping apparatus of one embodiment of the present disclosure, and is a flowchart of one Example of a three-dimensional shaped article production method that is different from the flowcharts in FIGS. 9 to 12.

### DESCRIPTION OF EXEMPLARY EMBODIMENTS

First, the present disclosure will be schematically described.

A three-dimensional shaping apparatus according to a first aspect of the present disclosure for solving the above problem is a three-dimensional shaping apparatus for shaping a stacked body by stacking layers using a shaping material, and includes a table at which the stacked body is shaped, a nozzle that ejects the shaping material, a sensor including at least one of a first sensor that detects a temperature of the shaping material ejected from the nozzle and a second sensor that detects an ejection state of the shaping material ejected from the nozzle, and a control unit that executes a feedback process for controlling drive of the three-dimensional shaping apparatus based on a detection result of the sensor, wherein the control unit executes the feedback process under first control when a first portion of the stacked body is shaped, executes the feedback process under second control when a second portion that is different from the first portion of the stacked body is shaped, and makes an execution frequency of the feedback process different between the first control and the second control.

According to this aspect, the execution frequency of the feedback process is made different between when the first portion is shaped and when the second portion is shaped. Therefore, as compared with a case where the shaping operation is performed while performing the feedback process at a constant frequency, the execution frequency of the feedback process in the shaping operation for a three-dimensional shaped article as a whole can be reduced, and the shaping time can be shortened.

In a three-dimensional shaping apparatus according to a second aspect of the present disclosure, in the first aspect, the first portion and the second portion are different layers, and the control unit determines whether a layer is the first portion or the second portion for each layer, and makes the execution frequency of the feedback process different for each layer.

According to this aspect, it is determined whether a layer is the first portion or the second portion for each layer, and the execution frequency of the feedback process is made different for each layer. Therefore, the feedback process can be simplified, and the shaping time for a three-dimensional shaped article can be particularly shortened.

In a three-dimensional shaping apparatus according to a third aspect of the present disclosure, in the first aspect, the first portion and the second portion are different sites in the same layer, and it is determined whether a site is the first portion or the second portion for each different site in the same layer, and the execution frequency of the feedback process is made different for each different site in the same layer.

According to this aspect, it is determined whether a site is the first portion or the second portion for each different site in the same layer, and the execution frequency of the feedback process is made different for each different site in the same layer. Therefore, a portion for which high shaping accuracy is required and a portion for which high shaping accuracy is not required can be determined in detail, so that a decrease in shaping accuracy of a three-dimensional shaped article can be effectively suppressed.

In a three-dimensional shaping apparatus according to a fourth aspect of the present disclosure, in any one of the first to third aspects, the control unit makes the execution frequency of the feedback process different by making a detection frequency by the sensor different between the first control and the second control.

According to this aspect, the execution frequency of the feedback process is made different by making the detection frequency by the sensor different between the first control and the second control. Therefore, by reducing the detection frequency by the sensor, the execution frequency of the feedback process in the shaping operation for a three-dimensional shaped article as a whole can be reduced.

In a three-dimensional shaping apparatus according to a fifth aspect of the present disclosure, in the fourth aspect, the first portion is a portion for which higher shaping accuracy is required than for the second portion, and the control unit makes the detection frequency in the first control higher than the detection frequency in the second control.

According to this aspect, the detection frequency for the first portion for which higher shaping accuracy is required than for the second portion is made higher than for the second portion. Therefore, the shaping time can be shortened while efficiently suppressing a decrease in shaping accuracy of a three-dimensional shaped article.

In a three-dimensional shaping apparatus according to a sixth aspect of the present disclosure, in the fifth aspect, the control unit prevents the sensor from performing detection under the second control.

According to this aspect, the sensor is made not to perform detection for the second portion for which high shaping accuracy is not required. Therefore, the execution frequency of the feedback process in the shaping operation for a three-dimensional shaped article as a whole can be particularly efficiently reduced.

In a three-dimensional shaping apparatus according to a seventh aspect of the present disclosure, in any one of the first to third aspects, the control unit makes the execution frequency of the feedback process different by making an adoption frequency of the detection result by the sensor different between the first control and the second control.

According to this aspect, the execution frequency of the feedback process is made different by making the adoption frequency of the detection result by the sensor different between the first control and the second control. Therefore, by reducing the adoption frequency of the detection result by the sensor, the execution frequency of the feedback process in the shaping operation for a three-dimensional shaped article as a whole can be reduced.

In a three-dimensional shaping apparatus according to an eighth aspect of the present disclosure, in the seventh aspect, the first portion is a portion for which higher shaping accuracy is required than for the second portion, and the control unit makes the adoption frequency in the first control higher than the adoption frequency in the second control.

According to this aspect, the adoption frequency of the detection result by the sensor for the first portion for which higher shaping accuracy is required than for the second portion is made higher than for the second portion. Therefore, the shaping time can be shortened while efficiently suppressing a decrease in shaping accuracy of a three-dimensional shaped article.

In a three-dimensional shaping apparatus according to a ninth aspect of the present disclosure, in the eighth aspect, the control unit does not adopt the detection result by the sensor under the second control.

According to this aspect, the detection result by the sensor for the second portion for which high shaping accuracy is not required is not adopted. Therefore, the execution frequency of the feedback process in the shaping operation for a three-dimensional shaped article as a whole can be particularly efficiently reduced.

In a three-dimensional shaping apparatus according to a tenth aspect of the present disclosure, in any one of the first to ninth aspects, the first sensor is included as the sensor, a first heating section that heats the shaping material ejected from the nozzle is included, and the control unit executes the feedback process for controlling a heating temperature by the first heating section according to a detection result by the first sensor.

According to this aspect, the feedback process for controlling a heating temperature by the first heating section is executed according to the temperature of the shaping material of the stacked body during shaping. Therefore, the feedback process can be executed according to the temperature of the stacked body during shaping.

In a three-dimensional shaping apparatus according to an eleventh aspect of the present disclosure, in any one of the first to tenth aspects, a plasticizing section that forms the shaping material by heating a material is included, the second sensor is included as the sensor, the plasticizing section includes a drive motor, a screw that rotates by the drive motor, and a second heating section, and forms the shaping material by rotating the screw while heating the material by the second heating section, and the control unit executes the feedback process by controlling at least one of a heating temperature by the second heating section and rotation of the screw according to a detection result by the second sensor.

According to this aspect, the feedback process is executed by controlling at least one of a heating temperature by the second heating section and rotation of the screw. Therefore, the feedback process can be executed by a simple method.

In a three-dimensional shaping apparatus according to a twelfth aspect of the present disclosure, in the eleventh aspect, the plasticizing section includes the screw having a groove formed face with a groove formed therein, and a barrel that has an opposed face opposed to the groove formed face and that is provided with a communication hole which communicates with the nozzle, and conveys the material supplied between the screw and the barrel toward the communication hole while heating and forms the shaping material by heating with the second heating section and rotation of the screw.

According to this aspect, the plasticizing section includes a so-called flat screw and a barrel. Therefore, the shaping material can be formed by efficiently plasticizing the material.

A three-dimensional shaped article production method according to a thirteenth aspect of the present disclosure is a three-dimensional shaped article production method for shaping a stacked body using a three-dimensional shaping apparatus and includes a detection step of detecting at least one of a temperature of an ejected shaping material and an ejection state of the ejected shaping material, and a feedback processing step of executing a feedback process for controlling drive of the three-dimensional shaping apparatus based on a detection result detected in the detection step, wherein in the feedback processing step, the feedback process is executed under first control when a first portion of the stacked body is shaped, the feedback process is executed under second control when a second portion that is different from the first portion of the stacked body is shaped, and an execution frequency of the feedback process is made different between the first control and the second control.

According to this aspect, the execution frequency of the feedback process is made different between when the first portion is shaped and when the second portion is shaped. Therefore, the execution frequency of the feedback process in the shaping operation for a three-dimensional shaped article as a whole can be reduced, and the shaping time can be shortened.

Hereinafter, embodiments according to the present disclosure will be described with reference to the accompanying drawings. The following drawings are all schematic views and some constituent members are omitted or simplified. Further, in the respective drawings, an X-axis direction is a horizontal direction, and a Y-axis direction is a horizontal direction and also a direction orthogonal to the X-axis direction, and a Z-axis direction is a vertical direction.

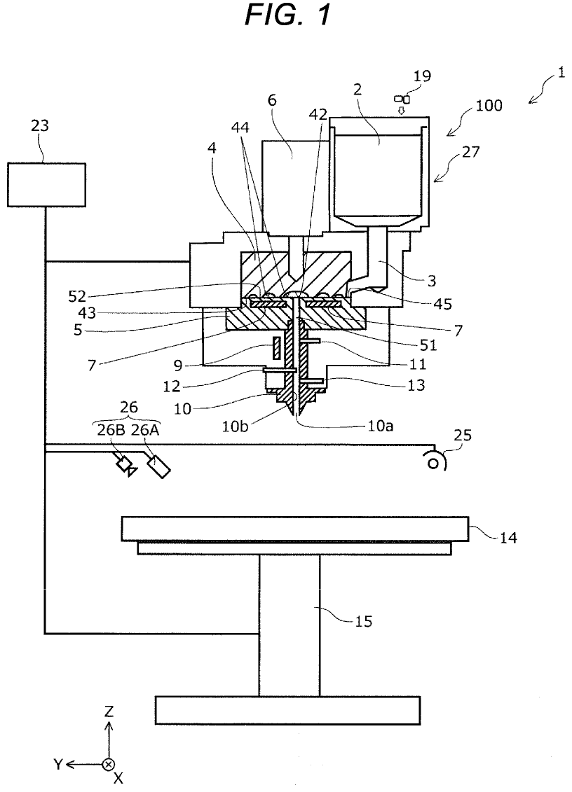

First, the entire configuration of a three-dimensional shaping apparatus 1 that is one embodiment of the present disclosure will be described with reference to FIGS. 1 to 4. The three-dimensional shaping apparatus 1 of this embodiment is a three-dimensional shaping apparatus for shaping a three-dimensional shaped article by stacking layers of a shaping material at a table 14 as a shaping stand. Note that the “three-dimensional shaping” as used herein refers to the formation of a so-called stereoscopically shaped article, and also includes, for example, the formation of a shape having a thickness even if it is in a flat plate shape or a so-called two-dimensional shape, for example, like a shape constituted by a layer corresponding to one layer.

As shown in FIG. 1, the three-dimensional shaping apparatus 1 of this embodiment includes a plasticizing section 27. The plasticizing section 27 includes a hopper 2 that stores a pellet 19 as a solid material constituting a three-dimensional shaped article. The pellet 19 stored in the hopper 2 is supplied, through a supply pipe 3, to a material inflow port 45 of a flat screw 4 in a substantially cylindrical shape that rotates around the Z-axis direction as a rotation axis by a driving force of a drive motor 6. The three-dimensional shaping apparatus 1 of this embodiment has a configuration in which a shaping material can be ejected while forming the shaping material using the flat screw 4, but is not limited to such a configuration. The apparatus may have a configuration in which the shaping material can be ejected while forming the shaping material using a so-called inline screw, a configuration employing a so-called FDM (fused deposition modeling) system in which a filament-like solid material is ejected while melting, or the like.

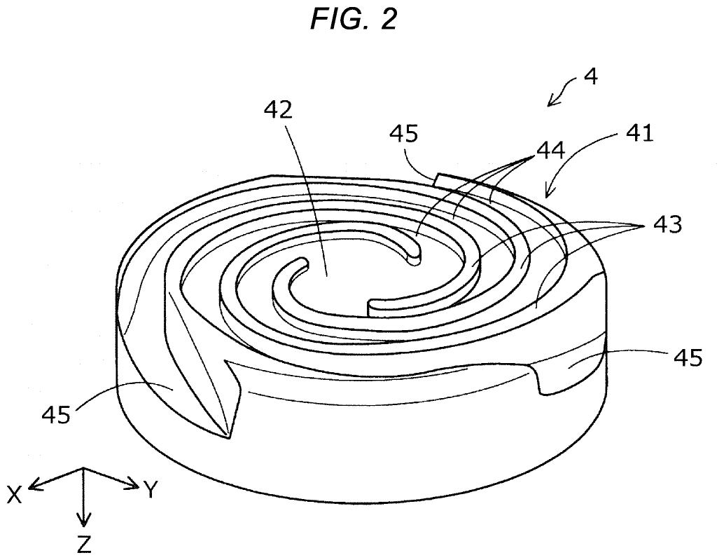

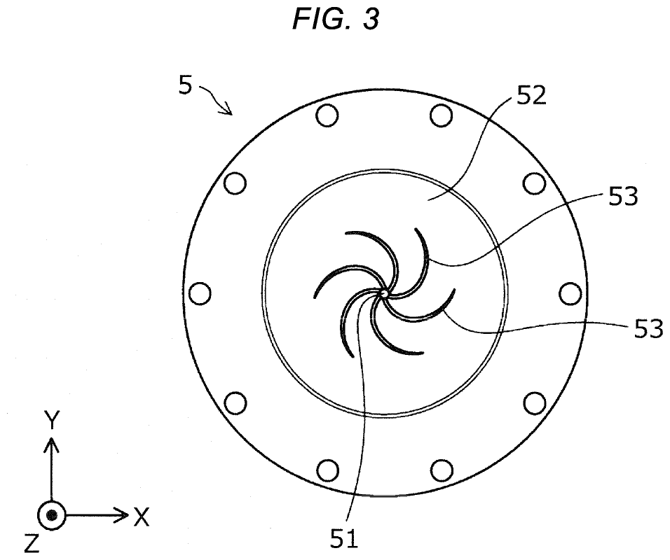

As shown in FIG. 2, a central portion 42 of a groove formed face 41 of the flat screw 4 is constituted as a recess to which one end of a groove 44 is coupled. The central portion 42 is opposed to a communication hole 51 of a barrel 5 shown in FIGS. 1 and 3. The groove 44 of the flat screw 4 is constituted by a so-called scroll groove and is formed in a spiral shape so as to draw an arc toward an outer circumferential face side of the flat screw 4 from the central portion 42. The groove 44 maybe configured in a helical shape. In the groove formed face 41, a protrusion portion 43 that constitutes a side wall portion of the groove 44 and extends along each groove 44 is provided.

In the groove formed face 41 of the flat screw 4 in this embodiment, three grooves 44 and three protrusion portions 43 are formed, however, the number thereof is not limited to three, and one or two or more arbitrary number of grooves 44 and protrusion portions 43 may be formed, respectively. Further, an arbitrary number of protrusion portions 43 may be provided according to the number of grooves 44. Further, in the outer circumferential face of the flat screw 4 in this embodiment, three material inflow ports 45 are formed so as to be arranged at equal intervals along the circumferential direction. The number of material inflow ports 45 is not limited to three, and one or two or more arbitrary number of material inflow ports 45 may be formed, and the arrangement is not limited to arrangement at equal intervals, and the material inflow ports may be formed so as to be arranged at different intervals.

As shown in FIG. 3, the barrel 5 has a substantially disk shape as the external shape and is disposed opposite to the groove formed face 41 of the flat screw 4. In the barrel 5, a circular heater 7 that is a heating section for heating the material is embedded. In the barrel 5, the communication hole 51 is formed. The communication hole 51 functions as a flow channel that guides the shaping material to a nozzle 10. The communication hole 51 is formed at the center of an opposed face 52. In the opposed face 52, a plurality of guide grooves 53, each of which is coupled to the communication hole 51, and extends in a spiral shape toward the outer circumference from the communication hole 51, are formed. The plurality of guide grooves 53 each have a function of guiding the shaping material flowing in the central portion 42 of the flat screw 4 to the communication hole 51. Note that in order to efficiently guide the shaping material to the communication hole 51, the guide groove 53 is preferably formed in the barrel 5, but the guide groove 53 need not be formed.

Since the flat screw 4 and the barrel 5 have such a configuration, by rotating the flat screw 4, the pellet 19 is supplied to a space portion formed between the groove formed face 41 of the flat screw 4 and the opposed face 52 of the barrel 5 corresponding to the position of the groove 44, and the pellet 19 moves to the central portion 42 from the material inflow port 45. When the pellet 19 moves in the space portion by the groove 44, the pellet 19 is melted by heat of the heater 7. Further, the pellet 19 is pressurized by a pressure accompanying the movement in the narrow space portion. In this manner, the pellet 19 is plasticized and supplied to the nozzle 10 through the communication hole 51 and injected from an ejection port 10a. In this embodiment, the heater 7 is embedded in the barrel 5, but the heater 7 may be disposed at any place as long as the pellet 19 is melted, and for example, the heater 7 may be embedded in the flat screw 4.

Further, as shown in FIG. 1, in the nozzle 10, a flow channel 10b that is coupled to the communication hole 51 and has the ejection port 10a in a tip portion is formed. That is, the communication hole 51 and the flow channel 10b constitute a moving path of the shaping material formed in the plasticizing section 27. Then, around the nozzle 10, a heater 9 that heats the shaping material flowing through the flow channel 10b, a pressure measurement section 11 that measures the internal pressure of the flow channel 10b, a flow rate adjustment mechanism 12 for the shaping material flowing through the flow channel 10b, and a suction section 13 that releases the internal pressure of the flow channel 10b are provided.

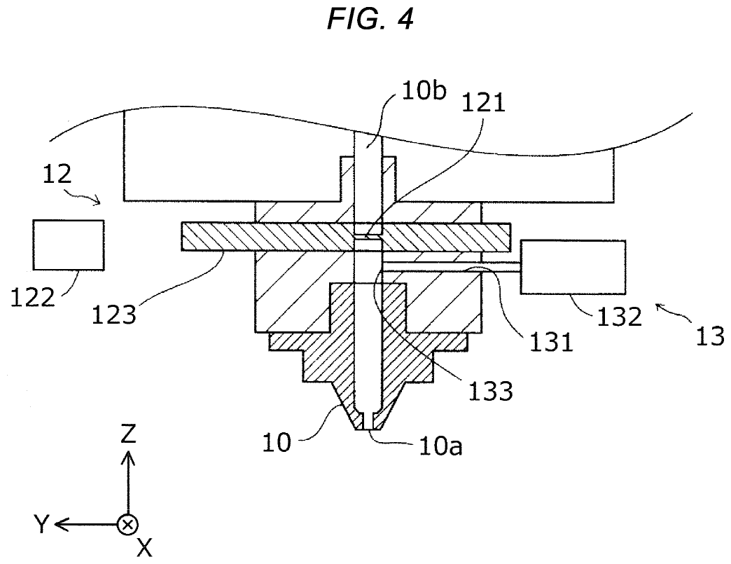

As shown in FIG. 4, the flow rate adjustment mechanism 12 includes a butterfly valve 121, a valve drive section 122, and a drive shaft 123. The flow rate adjustment mechanism 12 is provided in the flow channel 10b and controls the flow rate of the shaping material moving through the flow channel 10b. The butterfly valve 121 is a plate-shaped member obtained by processing a portion of the drive shaft 123 into a plate shape. The butterfly valve 121 is rotatably placed in the flow channel 10b. The drive shaft 123 is a shaft member provided so as to be perpendicular to the flow channel 10b and crosses the flow channel 10b at right angles. The drive shaft 123 is provided so that the position of the butterfly valve 121 becomes a position where the drive shaft 123 and the flow channel 10b cross each other.

The valve drive section 122 is a drive section having a mechanism for rotating the drive shaft 123. The butterfly valve 121 is rotated by the rotation drive force of the drive shaft 123 generated by the valve drive section 122. Specifically, the butterfly valve 121 is rotated by the rotation of the drive shaft 123 so that the position of the butterfly valve 121 is any of the following positions: a first position where the moving direction of the shaping material in the flow channel 10b (−Z direction) and the surface direction of the butterfly valve 121 become substantially perpendicular; a second position where the moving direction of the shaping material in the flow channel 10b and the surface direction of the butterfly valve 121 become substantially parallel; and a third position where the moving direction of the shaping material in the flow channel 10b and the surface direction of the butterfly valve 121 form any angle of more than 0° and less than 90°. In FIG. 4, a state where the position of the butterfly valve 121 is the first position is shown.

By rotating the butterfly valve 121, the area of the opening formed in the flow channel 10b is adjusted. By adjusting the area of the opening, the flow rate of the shaping material moving through the flow channel 10b is adjusted. Further, by bringing about a state where the area of the opening is zero (a state where the butterfly valve 121 closes the flow channel 10b) , a state where the flow rate of the shaping material moving through the flow channel 10b is zero can also be brought about. That is, the flow rate adjustment mechanism 12 can control start and stop of flowing of the shaping material moving through the flow channel 10b, and adjustment of the flow rate of the shaping material.

The suction section 13 is coupled between the butterfly valve 121 and the ejection port 10a in the flow channel 10b. The suction section 13 suppresses tailing that is a phenomenon in which the shaping material drips from the nozzle 10 and becomes stringy by temporality sucking the shaping material in the flow channel 10b when stopping the ejection of the shaping material from the nozzle 10. In this embodiment, the suction section 13 is constituted by a plunger. The suction section 13 is driven by a suction section drive section 132 under the control of the control unit 23. The suction section drive section 132 is constituted by, for example, a stepping motor, a rack and pinion mechanism that converts the rotational force of a stepping motor into a translational motion of a plunger, or the like.

A send-out port 133 is an opening provided in the flow channel 10b. A sending channel 131 is constituted by a through-hole that linearly extends and crosses the flow channel 10b. The sending channel 131 is a flow channel for a gas coupled to the suction section drive section 132 and the send-out port 133. A gas sent out from the suction section drive section 132 passes through the sending channel 131 and is sent into the flow channel 10b from the send-out port 133. The gas supplied into the flow channel 10b pressure-feeds the shaping material remaining in the flow channel 10b to the ejection port 10a side by further continuously supplying the gas from the suction section drive section 132. The pressure-fed shaping material is ejected from the ejection port 10a.

According to such a configuration, the three-dimensional shaping apparatus 1 of this embodiment can promptly eject the shaping material in the flow channel 10b from the ejection port 10a. Further, ejection of the molten shaping material from the ejection port 10a can be promptly stopped. Note that the shape of the opening of the send-out port 133 coupled to the flow channel 10b is smaller than the shape of the cross section perpendicular to the moving direction of the shaping material in the flow channel 10b. According to this, the shaping material moving in the flow channel 10b can be prevented from flowing in from the send-out port 133 and flowing backward inside the sending channel 131.

The three-dimensional shaping apparatus 1 of this embodiment includes the plasticizing section 27, the nozzle 10, and the like as described above, and these can move along the X-axis direction and the Y-axis direction as an ejection unit 100. The ejection unit 100 moves along the X-axis direction and the Y-axis direction by being controlled by the control unit 23. Then, at the position opposed to the ejection port 10a, the table 14 for shaping a three-dimensional shaped article is provided. The table 14 can move along the Z-axis direction through a moving mechanism 15 by being controlled by the control unit 23.

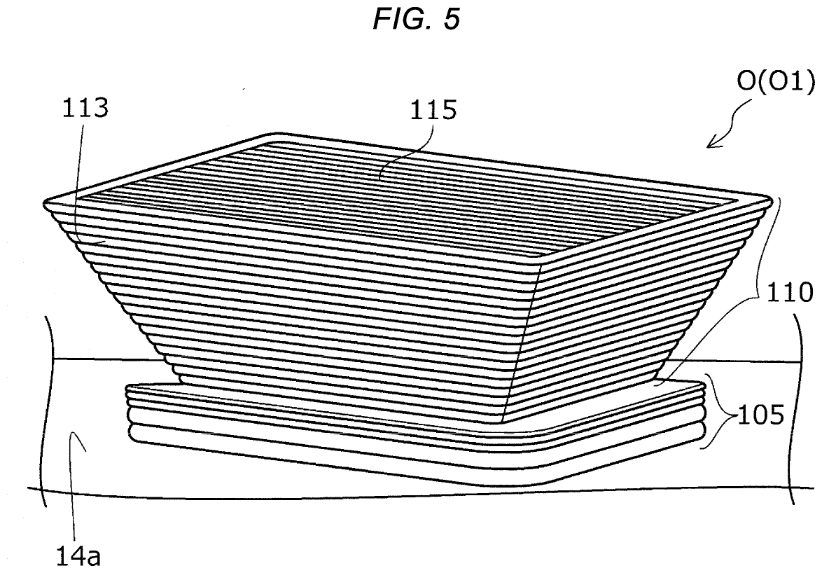

Further, as shown in FIG. 1, in the three-dimensional shaping apparatus 1 of this embodiment, a heater 25 capable of heating, for example, a stacked body O of a three-dimensional shaped article during shaping shown in FIG. 5 or the like is provided for the table 14. By changing the heating temperature by the heater 25, heating of the uppermost layer in the stacked body O during shaping can be adjusted. For example, by heating the stacked body O with the heater 25 when an N-th layer is formed, the viscosity of the shaping material of an (N−1)th layer that is a layer one layer below the N-th layer can be changed, and the adhesion of the N-th layer to the (N−1)th layer or the like can be adjusted. Note that the heater 25 of this embodiment is an infrared heater, but another type of heating section may be used.

Further, as shown in FIG. 1, the three-dimensional shaping apparatus 1 of this embodiment includes a non-contact type temperature sensor 26A capable of measuring the temperature of a shaping face 14a of the table 14 at which the stacked body O of a three-dimensional shaped article is shaped and the temperature of the stacked body O of a three-dimensional shaped article to be shaped at the shaping face 14a, and a video camera 26B capable of capturing an image of the shaping face 14a and the stacked body O of a three-dimensional shaped article to be shaped at the shaping face 14a. The temperature sensor 26A and the video camera 26B constitute a sensor section 26. The sensor section 26 may be provided in the ejection unit 100, but the sensor section 26 and the ejection unit 100 may be separately provided.

The three-dimensional shaping apparatus 1 of this embodiment includes the control unit 23, and the control unit 23 controls various drives of the three-dimensional shaping apparatus 1. The control unit 23 is electrically coupled to the ejection unit 100, the moving mechanism 15, the heater 25, and the sensor section 26. The respective constituent members of the three-dimensional shaping apparatus 1 are driven under the control of the control unit 23, and a shaping process or the like is executed. Although details will be described later, the shaping process is performed while executing a feedback process for controlling the drive of the three-dimensional shaping apparatus 1 based on the detection result by the sensor section 26. Examples of the feedback process include adjustment of the temperature of the shaping material or adjustment of the ejection amount thereof, and adjustment of the shaping speed of the stacked body O by adjusting the moving speed of the ejection unit 100. By executing the feedback process, the shaping process for shaping the stacked body 0 with high accuracy can be achieved, but the control load of the control unit 23 increases. Therefore, it is desirable to appropriately execute the feedback process when performing the shaping process of a site for which shaping with particularly high accuracy is required in the stacked body O while reducing the control load of the control unit 23 due to execution of the feedback process as much as possible.

Next, Examples of a three-dimensional shaped article production method to be executed using the three-dimensional shaping apparatus 1 of this embodiment will be described with reference to FIGS. 5 to 10. As described above, the three-dimensional shaping apparatus 1 of this embodiment is a three-dimensional shaping apparatus for shaping the stacked body O by stacking layers using the shaping material, and includes the table 14 at which the stacked body O is shaped, and the nozzle 10 that ejects the shaping material . In addition, the apparatus includes the sensor section 26 including the temperature sensor 26A as the first sensor that detects the temperature of the shaping material ejected from the nozzle 10, and the video camera 26B as the second sensor that detects the ejection state of the shaping material based on an image of the shaping material ejected from the nozzle 10. Further, the apparatus includes the control unit 23 that executes the feedback process for controlling the drive of the three-dimensional shaping apparatus 1 when shaping the stacked body O based on the detection result of the sensor section 26.

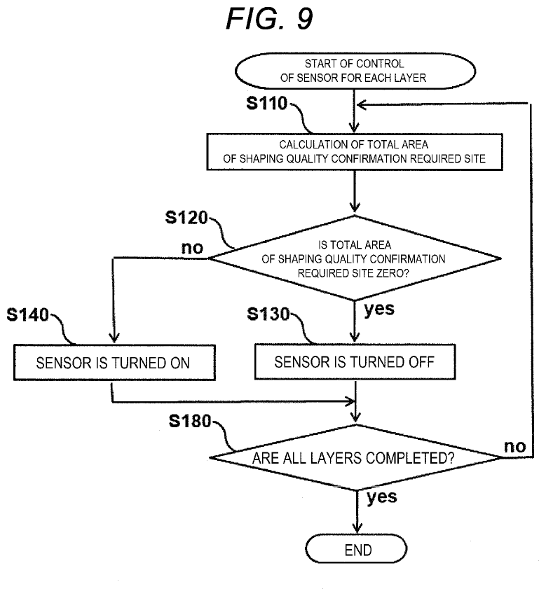

First, an Example of a three-dimensional shaped article production method shown in the flowchart in FIG. 9 will be described with reference to FIG. 5. The three-dimensional shaped article production method shown in the flowchart in FIG. 9 is a method for shaping the stacked body O by changing a method for controlling the sensor section 26 every time that a layer corresponding to one layer is formed when shaping the stacked body O by stacking layers.

When the three-dimensional shaped article production method of this Example is started, first, in Step S110, the control unit 23 determines a shaping quality confirmation required site that is a site for which high shaping quality is required in the stacked body O and a shaping quality confirmation unrequired site that is a site for which high shaping quality is not required in the stacked body O based on data for one layer of the stacked body O to be shaped. Then, the total area of the shaping quality confirmation required site is calculated from the data for one layer.

Subsequently, in Step S120, the control unit 23 determines whether or not the total area of the shaping quality confirmation required site calculated in Step S110 is zero. When the control unit 23 determines that the total area of the shaping quality confirmation required site is zero, the process proceeds to Step S130, and when the control unit 23 determines that the total area of the shaping quality confirmation required site is not zero, the process proceeds to Step S140. In this Example, it is determined whether or not the total area of the shaping quality confirmation required site is 0, however, the determination standard may be set to a predetermined threshold other than zero.

In Step S130, the sensor section 26 is turned off, and the shaping process is performed in a state where the sensor section 26 is turned off. That is, the shaping process is performed without performing the feedback process based on the detection result of the sensor section 26. Here, the shaping process means a process for forming a layer of the shaping material on the shaping face 14a of the table 14 by ejecting the shaping material from the nozzle 10 while controlling the ejection unit 100 and the table 14 by the control unit 23. Then, when the shaping process based on the data for one layer in a state where the sensor section 26 is turned off is completed, the process proceeds to Step S180.

Here, the stacked body 01 shown in FIG. 5 includes a three-dimensional shaped article region 110 as a three-dimensional shaped article that is a shaping target by a user, and a support platform region 105 that supports the three-dimensional shaped article region 110. Here, the “support” is meant to include not only a case of supporting from a lower side, but also a case of supporting from a lateral side, and a case of supporting from an upper side in some cases . The support platform region 105 is separated from the three-dimensional shaped article region 110 after completion of the stacked body O1. By forming the support platform region 105 on the shaping face 14a, and then forming the three-dimensional shaped article region 110 thereon, the three-dimensional shaped article region 110 can be formed with higher accuracy than when the three-dimensional shaped article region 110 is formed directly on the shaping face 14a. This is because the effect of the unevenness of the shaping face 14a can be avoided, or shifting of the three-dimensional shaped article region 110 with respect to the shaping face 14a can be avoided, or the like.

The support platform region 105 is separated from the three-dimensional shaped article region 110 after completion of the stacked body 01, and therefore, it is not necessary to shape the support platform region 105 with high accuracy. Therefore, for example, when the stacked body 01 shown in FIG. 5 is formed, when the support platform region 105 is formed, the control unit 23 determines that a site corresponding to the support platform region 105 is the shaping quality confirmation unrequired site based on the data for one layer in Step S110 and Step S120. Then, with respect to a layer including only the site corresponding to the support platform region 105, the shaping process is executed in a state where the sensor section 26 is turned off in Step S130.

On the other hand, in Step S140, the sensor section 26 is turned on, and the shaping process is performed in a state where the sensor section 26 is turned on. That is, the shaping process is performed while performing the feedback process based on the detection result of the sensor section 26. Then, when the shaping process based on the data for one layer in a state where the sensor section 26 is turned on is completed, the process proceeds to Step 5180.

For example, when the stacked body O1 shown in FIG. 5 is formed, when the three-dimensional shaped article region 110 is formed, the control unit 23 determines that a site corresponding to the three-dimensional shaped article region 110 is the shaping quality confirmation required site based on the data for one layer in Step S110 and Step S120. Then, with respect to a layer including the site corresponding to the three-dimensional shaped article region 110, the shaping process is executed in a state where the sensor section 26 is turned on in Step S140.

Then, in Step S180, the control unit 23 determines whether or not the shaping process for all layers regarding the stacked body O to be shaped, that is, for all data input by the three-dimensional shaping apparatus 1 is completed. When it is determined that the shaping process for all layers regarding the stacked body O to be shaped is not completed, the process returns to Step S110, and Step S110 to Step S180 are repeated until the shaping process for all layers regarding the stacked body O to be shaped is completed. Then, when it is determined that the shaping process for all data regarding the stacked body O to be shaped is completed, the three-dimensional shaped article production method of this Example is completed.

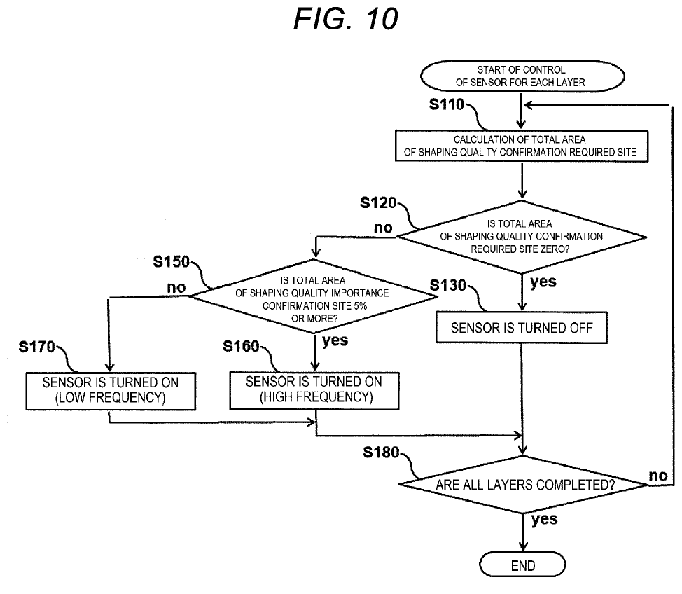

Next, an Example of a three-dimensional shaped article production method shown in the flowchart in FIG. 10 will be described with reference to FIGS. 5 to 8. The three-dimensional shaped article production method shown in the flowchart in FIG. 10 is also a method for shaping the stacked body O by changing a method for controlling the sensor section 26 every time that a layer corresponding to one layer is formed when shaping the stacked body O by stacking layers in the same manner as the three-dimensional shaped article production method shown in the flowchart in FIG. 9.

Note that in the three-dimensional shaped article production method shown in the flowchart in FIG. 10, Step S110 to Step S130 and Step S180 are the same as Step S110 to Step S130 and Step S180 in the three-dimensional shaped article production method shown in the flowchart in FIG. 9, and therefore, the detailed description thereof will be omitted.

In the three-dimensional shaped article production method of this Example, when it is determined that the total area of the shaping quality confirmation required site is not zero in Step S120, the process proceeds to Step S150. Then, in Step S150, the control unit 23 determines whether or not the total area of a shaping quality importance confirmation site is 5% or more. Specifically, the control unit 23 determines a shaping quality importance confirmation site that is a site for which particularly high shaping quality is required in the shaping quality confirmation required site and a site other than this based on data for one layer of the stacked body O to be shaped. Then, the control unit 23 calculates the total area of the shaping quality importance confirmation site from the data for one layer, and determines whether or not the calculated total area of the shaping quality importance confirmation site is 5% or more of the shaping quality confirmation required site.

In Step 5150, when the control unit 23 determines that the total area of the shaping quality importance confirmation site is 5% or more, the process proceeds to Step S160, and when the control unit 23 determines that the total area of the shaping quality importance confirmation site is not 5% or more, the process proceeds to Step 5170. Note that in this Example, it is determined whether or not the total area of the shaping quality importance confirmation site is 5% or more as the predetermined threshold, however, the determination standard may be set to a threshold other than 5%, or zero or not.

In Step 5160, the sensor section 26 is turned on, and the shaping process is performed while performing the feedback process at a high frequency based on the detection result by the sensor section 26. Then, when the shaping process based on the data for one layer while performing the feedback process at a high frequency is completed, the process proceeds to Step S180.

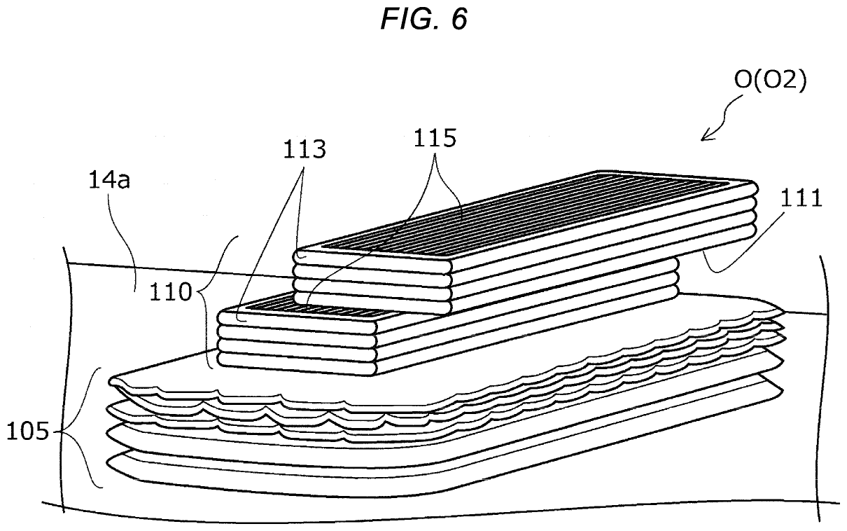

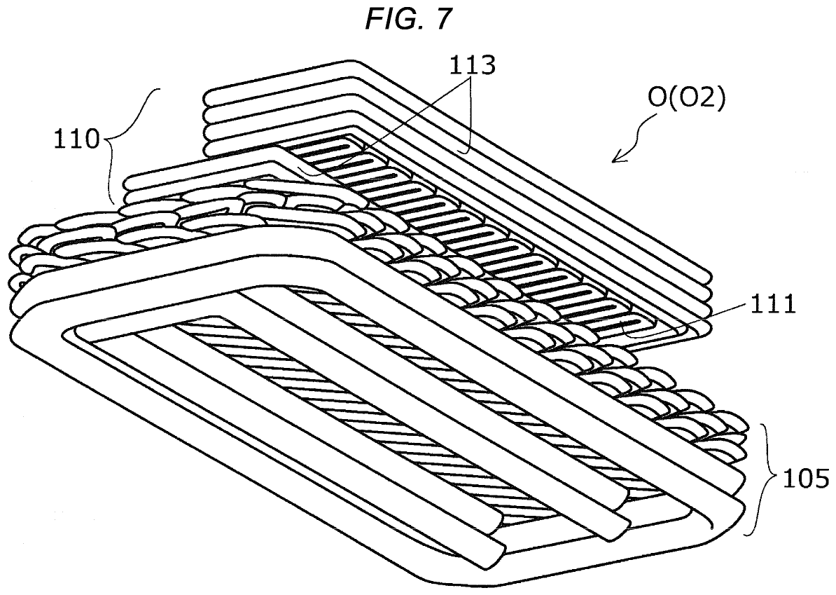

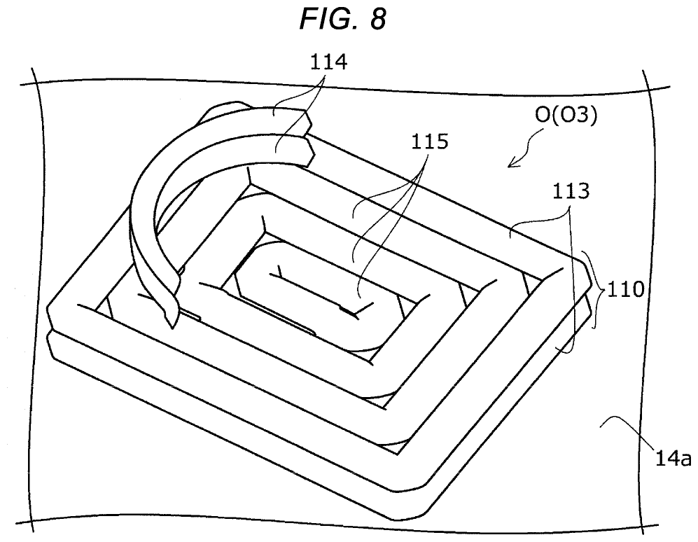

Here, the stacked body O1 shown in FIG. 5 includes, as the three-dimensional shaped article region 110, a contour region 113 and an internal region 115 that is an inner region surrounded by the contour region 113. Between these regions, the contour region 113 is a region that determines the shape of the three-dimensional shaped article, and therefore need to be shaped with high accuracy. Further, a stacked body O2 shown in FIGS. 6 and 7 includes an overhang region 111 in the three-dimensional shaped article region 110 in addition to the contour region 113 and the internal region 115. Here, the overhang region 111 is a region that is not supported by a lower layer. The overhang region 111 is easily deformed by gravity, and therefore need to be shaped with high accuracy. Further, a stacked body O3 shown in FIG. 8 includes a thin wall-like region 114 in an arch shape with a narrow width in the three-dimensional shaped article region 110 in addition to the contour region 113 and the internal region 115. Here, the thin wall-like region 114 has a narrow width and is easily deformed, and therefore need to be shaped with high accuracy. Accordingly, in this Example, the contour region 113, the overhang region 111, and the thin wall-like region 114 are each determined to be the shaping quality importance confirmation site. However, a region other than these may be set as the shaping quality importance confirmation site.

On the other hand, in Step S170, the sensor section 26 is turned on, and the shaping process is performed while performing the feedback process at a lower frequency than the frequency of the feedback process in Step S160 based on the detection result of the sensor section 26. Then, when the shaping process based on the data for one layer while performing the feedback process at a low frequency is completed, the process proceeds to Step S180.

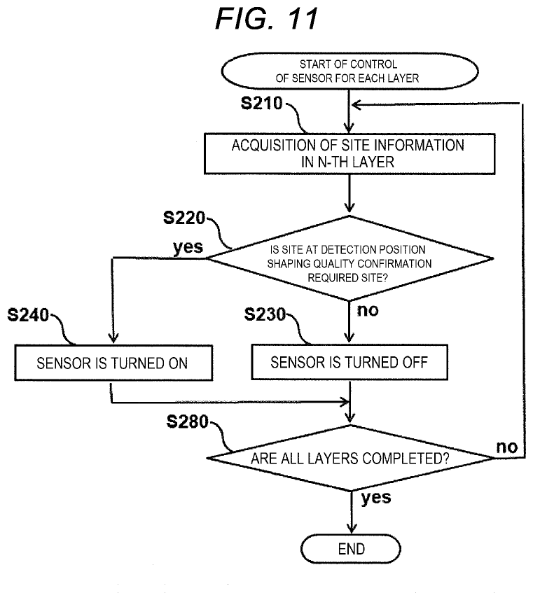

Next, an Example of a three-dimensional shaped article production method shown in the flowchart in FIG. 11 will be described with reference to FIG. 5. The three-dimensional shaped article production method shown in the flowchart in FIG. 11 is a method for shaping the stacked body O by changing a method for controlling the sensor section 26 for each site in a layer corresponding to one layer based on data input by the three-dimensional shaping apparatus 1 when shaping the stacked body O by stacking layers.

When the three-dimensional shaped article production method of this Example is started, first, in Step S210, the control unit 23 acquires information of a shaping quality confirmation required site that is a site for which high shaping quality is required in the stacked body O and a shaping quality confirmation unrequired site that is a site for which high shaping quality is not required in the stacked body O in an N-th layer for which shaping is started based on data for one layer of the stacked body O to be shaped.

Here, as described above, the stacked body O1 shown in FIG. 5 includes a contour region 113 and an internal region 115 that is an inner region surrounded by the contour region 113 as the three-dimensional shaped article region 110. Between these regions, the contour region 113 is a region that determines the shape of a three-dimensional shaped article, and therefore need to be shaped with high accuracy. Therefore, in the Example of the three-dimensional shaped article production method shown in the flowchart in FIG. 11, the contour region 113 is determined to be the shaping quality confirmation required site and the internal region 115 is determined to be the shaping quality confirmation unrequired site, and the stacked body O is shaped by changing a method for controlling the sensor section 26 for each site in a layer corresponding to one layer.

Subsequently, in Step S220, the control unit 23 determines whether a site at a current detection position by the sensor section 26 is the shaping quality confirmation required site (contour region 113) or not (internal region 115) based on the site information acquired in Step S210. When it is determined that the site at the current detection position is not the shaping quality confirmation required site by the control unit 23, the process proceeds to Step S230, and when it is determined that the site at the current detection position is the shaping quality confirmation required site by the control unit 23, the process proceeds to Step S240. Note that the detection position by the sensor section 26 is preferably as near as possible to the ejection position from the nozzle 10.

In Step S230, the sensor section 26 is turned off, and the shaping process is performed in a state where the sensor section 26 is turned off. That is, the shaping process is performed without performing the feedback process based on the detection result of the sensor section 26. For example, when the stacked body O1 shown in FIG. 5 is formed, when the detection position of the sensor section 26 corresponds to the internal region 115, the shaping process is performed in a state where the sensor section 26 is turned off.

On the other hand, in Step S240, the sensor section 26 is turned on, and the shaping process is performed in a state where the sensor section 26 is turned on. That is, the shaping process is performed while performing the feedback process based on the detection result of the sensor section 26. For example, when the stacked body O1 shown in FIG. 5 is formed, when the detection position of the sensor section 26 corresponds to the contour region 113, the shaping process is performed in a state where the sensor section 26 is turned on.

Note that the steps from Step S210 to Step S240 are repeatedly and continuously performed based on data for one layer corresponding to the N-th layer until the shaping process for one layer is completed. Then, when the shaping process for the N-th layer is completed, the process proceeds to Step S280.

Then, in Step S280, the control unit 23 determines whether or not the shaping process for all layers regarding the stacked body O to be shaped, that is, for all data input by the three-dimensional shaping apparatus 1 is completed. When it is determined that the shaping process for all layers regarding the stacked body O to be shaped is not completed, the process returns to Step S210, and shaping of a (N+1)th layer that is the next layer is started. That is, Step S210 to Step S280 are repeated until the shaping process for all layers regarding the stacked body O to be shaped is completed. Then, when it is determined that the shaping process for all data regarding the stacked body O to be shaped is completed, the three-dimensional shaped article production method of this Example is completed.

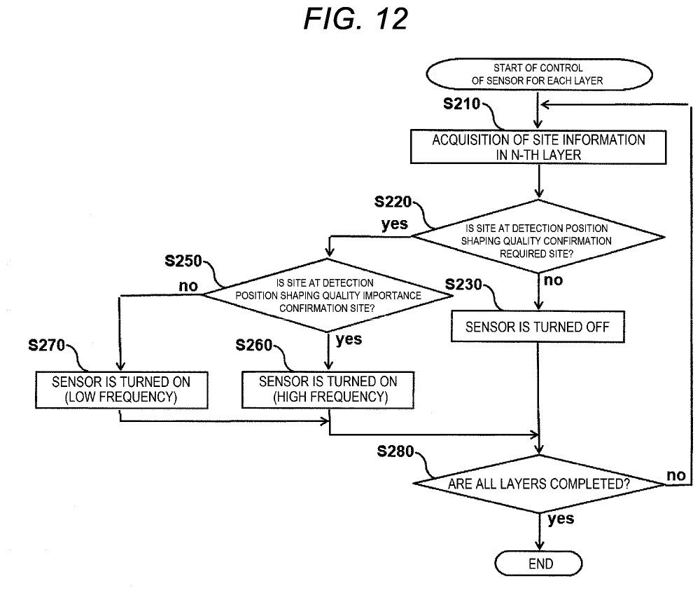

Next, an Example of a three-dimensional shaped article production method shown in the flowchart in FIG. 12 will be described with reference to FIG. 8. The three-dimensional shaped article production method shown in the flowchart in FIG. 12 is also a method for shaping the stacked body O by changing a method for controlling the sensor section 26 for each site in a layer corresponding to one layer based on data input by the three-dimensional shaping apparatus 1 when shaping the stacked body O by stacking layers in the same manner as the three-dimensional shaped article production method shown in the flowchart in FIG. 11.

Note that in the three-dimensional shaped article production method shown in the flowchart in FIG. 12, Step S210 to Step S230 and Step S280 are the same as Step S210 to Step S230 and Step S280 in the three-dimensional shaped article production method shown in the flowchart in FIG. 11, and therefore, the detailed description thereof will be omitted.

In the three-dimensional shaped article production method of this Example, when it is determined that the site at the current detection position by the sensor section 26 is the shaping quality confirmation required site in Step S220, the process proceeds to Step S250. Then, in Step S250, the control unit 23 determines whether or not the site at the current detection position of the sensor section 26 is the shaping quality importance confirmation site. Specifically, the control unit 23 determines the shaping quality importance confirmation site that is a site for which particularly high shaping quality is required in the shaping quality confirmation required site and a site other than this based on data for one layer of the stacked body O to be shaped. Then, the control unit 23 determines whether or not the site at the current detection position of the sensor section 26 is the shaping quality importance confirmation site based on the data for one layer.

Here, as described above, the stacked body O3 shown in FIG. 8 includes the thin wall-like region 114 in an arch shape with a narrow width in the three-dimensional shaped article region 110 in addition to the contour region 113 and the internal region 115. Among these, the contour region 113 and the thin wall-like region 114 are regions that determine the shape of the three-dimensional shaped article, and therefore need to be shaped with high accuracy. Accordingly, in the Example of the three-dimensional shaped article production method shown in the flowchart in FIG. 12, the contour region 113 and the thin wall-like region 114 are each determined to be the shaping quality confirmation required site, and the internal region 115 is determined to be the shaping quality confirmation unrequired site, and the stacked body O is shaped by changing the method for controlling the sensor section 26 for each site in a layer corresponding to one layer. Further, with respect to the contour region 113 and the thin wall-like region 114 as the shaping quality confirmation required site, the thin wall-like region 114 need to be shaped with higher accuracy. Therefore, in the Example of the three-dimensional shaped article production method shown in the flowchart in FIG. 12, the thin wall-like region 114 is determined to be the shaping quality importance confirmation site, and the contour region 113 is determined to be a site other than this, and the stacked body O is shaped by changing the method for controlling the sensor section 26 for each site in a layer corresponding to one layer.

In Step S260, the sensor section 26 is turned on, and the shaping process is performed while performing the feedback process at a high frequency based on the detection result of the sensor section 26. For example, when the stacked body O3 shown in FIG. 8 is formed, when the detection position of the sensor section 26 corresponds to the thin wall-like region 114, the sensor section 26 is turned on and the shaping process is performed while performing the feedback process at a high frequency.

On the other hand, in Step S270, the sensor section 26 is turned on, and the shaping process is performed while performing the feedback process at a lower frequency than the frequency of the feedback process in Step S260 based on the detection result of the sensor section 26. For example, when the detection position of the sensor section 26 corresponds to the contour region 113, the sensor section 26 is turned on and the shaping process is performed while performing the feedback process at a low frequency. Whether the feedback process is performed at a high frequency or a low frequency may be performed by changing the detection frequency by the sensor section 26, but maybe performed by changing the adoption frequency of the detection result to be used in the feedback process while making the detection frequency by the sensor section 26 common.

Note that Step S210 to Step S270 are continuously performed for each site as a given shaping unit during shaping of the N-th layer based on the data for one layer of the stacked body O to be shaped. Then, when the shaping process for the N-th layer is completed, the process proceeds to Step S280.

As described above, in the three-dimensional shaping apparatus 1 of this embodiment, under the control of the control unit 23, the feedback process for controlling the drive of the three-dimensional shaping apparatus 1 when shaping the stacked body O based on the detection result of the sensor section 26 can be executed under the control for performing the feedback process as the first control (Step S140 and Step S240) when the shaping quality confirmation required site as the first portion of the stacked body O is shaped, and can be executed under the second control (Step S130 and Step S230) in which the feedback process is not performed when the second portion (shaping quality confirmation unrequired site) that is different from the first portion of the stacked body O is shaped.

Further, expressed in another way, in the three-dimensional shaping apparatus 1 of this embodiment, under the control of the control unit 23, the feedback process for controlling the drive of the three-dimensional shaping apparatus 1 when shaping the stacked body O based on the detection result of the sensor section 26 is executed under the control for performing the feedback process at a high frequency as the first control (Step S160 and Step S260) when the shaping quality importance confirmation site as the first portion of the stacked body O is shaped, and is executed under the second control (Step S170 and Step S270) which is different from the first control when the second portion (a site other than the shaping quality importance confirmation site of the shaping quality confirmation required site) that is different from the first portion of the stacked body O is shaped, and the execution frequency of the feedback process can be made different between the first control and the second control.

In this manner, in the three-dimensional shaping apparatus 1 of this embodiment, the execution frequency of the feedback process can be made different between when the first portion is shaped and when the second portion is shaped. That is, when a portion for which high shaping accuracy is required is shaped, the execution frequency of the feedback process can be increased, and when a portion for which high shaping accuracy is not required is shaped, the execution frequency of the feedback process can be reduced. Therefore, in the three-dimensional shaping apparatus 1 of this embodiment, the execution frequency of the feedback process in the shaping operation for a three-dimensional shaped article as a whole can be reduced, and the shaping time can be shortened while suppressing a decrease in shaping accuracy of a three-dimensional shaped article.

As shown in the flowcharts in FIGS. 9 and 10, in the three-dimensional shaping apparatus 1 of this embodiment, under the control of the control unit 23, the shaping process can be executed while performing the feedback process which is different for each layer. Expressed in another way, the control unit 23 determines whether a layer is the first portion or the second portion for each layer, and the execution frequency of the feedback process can be made different for each layer. Therefore, in the three-dimensional shaping apparatus 1 of this embodiment, the feedback process can be simplified, and the shaping time for a three-dimensional shaped article can be particularly shortened.

On the other hand, as shown in the flowcharts in FIGS. 11 and 12, in the three-dimensional shaping apparatus 1 of this embodiment, the shaping process can be executed while performing the feedback process which is different for each different site in the same layer. Expressed in another way, in the three-dimensional shaping apparatus 1 of this embodiment, while assuming the first portion and the second portion as different sites in the same layer, it can be determined whether a site is the first portion or the second portion for each different site in the same layer, and the execution frequency of the feedback process can be made different for each different site in the same layer. Therefore, in the three-dimensional shaping apparatus 1 of this embodiment, a portion for which high shaping accuracy is required and a portion for which high shaping accuracy is not required can be determined in detail, and a decrease in shaping accuracy of a three-dimensional shaped article can be effectively suppressed.

In the three-dimensional shaped article production method shown in the flowcharts in FIGS. 9 to 12, the frequency of the feedback process in the shaping process is changed for each layer or each site. Here, in the three-dimensional shaping apparatus 1 of this embodiment, the control unit 23 can make the execution frequency of the feedback process different by making the detection frequency by the sensor section 26 different between the first control and the second control. Therefore, in the three-dimensional shaping apparatus 1 of this embodiment, the execution frequency of the feedback process in the shaping operation for a three-dimensional shaped article as a whole can be reduced by reducing the detection frequency by the sensor section 26.

More specifically, as described above, in the three-dimensional shaping apparatus 1 of this embodiment, while assuming the first portion as a portion for which higher shaping accuracy is required than for the second portion, under the control of the control unit 23, the detection frequency in the first control can be made higher than the detection frequency in the second control. Therefore, in the three-dimensional shaping apparatus 1 of this embodiment, the shaping time can be shortened while efficiently suppressing a decrease in shaping accuracy of a three-dimensional shaped article.

Here, in the three-dimensional shaping apparatus 1 of this embodiment, as shown in Step S130 and Step S230 in the flowcharts in FIGS. 9 to 12, the control unit 23 can prevent the sensor section 26 from performing detection under the second control. Therefore, in the three-dimensional shaping apparatus 1 of this embodiment, the execution frequency of the feedback process in the shaping operation for a three-dimensional shaped article as a whole can be particularly efficiently reduced.

On the other hand, in the three-dimensional shaping apparatus 1 of this embodiment, the control unit 23 can also make the execution frequency of the feedback process different not by making the detection frequency by the sensor section 26 different between the first control and the second control, but by making the adoption frequency of the detection result by the sensor section 26 different between the first control and the second control. That is, for example, the execution frequency of the feedback process can also be made different by making the adoption frequency of the detection result by the sensor section 26 different between the first control and the second control in a state where the detection frequency by the sensor section 26 is set to the same frequency between the first control and the second control. Therefore, in the three-dimensional shaping apparatus 1 of this embodiment, the execution frequency of the feedback process in the shaping operation for a three-dimensional shaped article as a whole can be reduced by reducing the adoption frequency of the detection result by the sensor section 26. Note that the detection frequency by the sensor section 26 may be made different between the first control and the second control, and also the adoption frequency of the detection result by the sensor section 26 may be made different between the first control and the second control.

More specifically, as described above, in the three-dimensional shaping apparatus 1 of this embodiment, while assuming the first portion as a portion for which higher shaping accuracy is required than for the second portion, under the control of the control unit 23, the adoption frequency of the detection result by the sensor section 26 in the first control can be made higher than the adoption frequency of the detection result by the sensor section 26 in the second control. Therefore, in the three-dimensional shaping apparatus 1 of this embodiment, the shaping time can be shortened while efficiently suppressing a decrease in shaping accuracy of a three-dimensional shaped article.

Here, in the three-dimensional shaping apparatus 1 of this embodiment, as shown in Step S130 and Step S230 in the flowcharts in FIGS. 9 to 12, the control unit 23 can prevent the sensor section 26 from performing detection under the second control. Therefore, in the three-dimensional shaping apparatus 1 of this embodiment, the execution frequency of the feedback process in the shaping operation for a three-dimensional shaped article as a whole can be particularly efficiently reduced.

As described above, the three-dimensional shaping apparatus 1 of this embodiment includes the temperature sensor 26A as the first sensor that is the sensor included in the sensor section 26, and the heater 25 as the first heating section that heats the shaping material ejected from the nozzle 10. Then, the control unit 23 can execute the feedback process for controlling the heating temperature by the heater 25 according to the detection result by the temperature sensor 26A. Therefore, in the three-dimensional shaping apparatus 1 of this embodiment, the feedback process can be executed according to the temperature of the stacked body during shaping.

Further, as described above, the three-dimensional shaping apparatus 1 of this embodiment includes the plasticizing section 27 that forms the shaping material by heating a solid material, and the video camera 26B as the second sensor that is the sensor included in the sensor section 26. Then, the plasticizing section 27 includes the drive motor 6, the flat screw 4 as the screw that rotates by the drive motor 6, and the heater 7 as the second heating section, and forms the shaping material by rotating the flat screw 4 while heating the pellet 19 that is the solid material by the heater 7. Here, the control unit 23 can execute the feedback process by controlling at least one of the heating temperature by the heater 7 and the rotation of the flat screw 4 according to the detection result by the video camera 26B. Therefore, in the three-dimensional shaping apparatus 1 of this embodiment, the feedback process can be executed by a simple method. Note that the three-dimensional shaping apparatus 1 of this embodiment is configured to include the video camera 26B as the second sensor, however, the second sensor is not limited to the video camera 26B as long as it is configured to be able to detect the ejection state of the shaping material ejected from the nozzle 10.

The plasticizing section 27 in the three-dimensional shaping apparatus 1 of this embodiment includes the flat screw 4 having the groove formed face 41 with the groove 44 formed therein and the barrel 5 that has the opposed face 52 opposed to the groove formed face 41 and that is provided with the communication hole 51 which communicates with the nozzle 10. Then, the plasticizing section 27 can convey the solid material supplied between the flat screw 4 and the barrel 5 toward the communication hole 51 while heating, and form the shaping material by heating with the heater 7 and rotation of the flat screw 4. Accordingly, in the three-dimensional shaping apparatus 1 of this embodiment, the shaping material can be formed by efficiently plasticizing the solid material.

The present disclosure is not limited to the above-mentioned Examples, but can be realized in various configurations without departing from the gist of the present disclosure. The technical features in the Examples corresponding to the technical features in the respective forms described in “SUMMARY” of the present disclosure may be appropriately replaced or combined in order to solve part or all of the problems described above or achieve part or all of the advantageous effects described above. Further, the technical features may be appropriately deleted unless they are described as essential features in the specification.

What is claimed is:

1. A three-dimensional shaping apparatus for shaping a stacked body by stacking layers using a shaping material, comprising:
a table at which the stacked body is shaped;
a nozzle that ejects the shaping material;
a sensor including at least one of a first sensor that detects a temperature of the shaping material ejected from the nozzle and a second sensor that detects an ejection state of the shaping material ejected from the nozzle; and
a control unit that executes a feedback process for controlling drive of the three-dimensional shaping apparatus based on a detection result of the sensor, wherein
the control unit
executes the feedback process under first control when a first portion of the stacked body is shaped,
executes the feedback process under second control when a second portion that is different from the first portion of the stacked body is shaped, and
makes an execution frequency of the feedback process different between the first control and the second control.

2. The three-dimensional shaping apparatus according to claim 1, wherein
the first portion and the second portion are different layers, and
the control unit determines whether a layer is the first portion or the second portion for each layer, and makes the execution frequency of the feedback process different for each layer.

3. The three-dimensional shaping apparatus according to claim 1, wherein
the first portion and the second portion are different sites in the same layer, and
it is determined whether a site is the first portion or the second portion for each different site in the same layer, and the execution frequency of the feedback process is made different for each different site in the same layer.

4. The three-dimensional shaping apparatus according to claim 1, wherein
the control unit makes the execution frequency of the feedback process different by making a detection frequency by the sensor different between the first control and the second control.

5. The three-dimensional shaping apparatus according to claim 4, wherein
the first portion is a portion for which higher shaping accuracy is required than for the second portion, and
the control unit makes the detection frequency in the first control higher than the detection frequency in the second control.

6. The three-dimensional shaping apparatus according to claim 5, wherein
the control unit prevents the sensor from performing detection under the second control.

7. The three-dimensional shaping apparatus according to claim 1, wherein
the control unit makes the execution frequency of the feedback process different by making an adoption frequency of the detection result by the sensor different between the first control and the second control.

8. The three-dimensional shaping apparatus according to claim 7, wherein
the first portion is a portion for which higher shaping accuracy is required than for the second portion, and
the control unit makes the adoption frequency in the first control higher than the adoption frequency in the second control.

9. The three-dimensional shaping apparatus according to claim 8, wherein
the control unit does not adopt the detection result by the sensor under the second control.

10. The three-dimensional shaping apparatus according to claim 1, wherein
the first sensor is included as the sensor,
a first heating section that heats the shaping material ejected from the nozzle is included, and
the control unit executes the feedback process for controlling a heating temperature by the first heating section according to a detection result by the first sensor.

11. The three-dimensional shaping apparatus according to claim 1, wherein
a plasticizing section that forms the shaping material by heating a material is included,
the second sensor is included as the sensor,
the plasticizing section includes a drive motor, a screw that rotates by the drive motor, and a second heating section, and forms the shaping material by rotating the screw while heating the material by the second heating section, and
the control unit executes the feedback process by controlling at least one of a heating temperature by the second heating section and rotation of the screw according to a detection result by the second sensor.

12. The three-dimensional shaping apparatus according to claim 11, wherein
the plasticizing section includes the screw having a groove formed face with a groove formed therein, and a barrel that has an opposed face opposed to the groove formed face and that is provided with a communication hole which communicates with the nozzle, and
conveys the material supplied between the screw and the barrel toward the communication hole while heating and forms the shaping material by heating with the second heating section and rotation of the screw.

13. A three-dimensional shaped article production method is a three-dimensional shaped article production method for shaping a stacked body using a three-dimensional shaping apparatus, comprising:
a detection step of detecting at least one of a temperature of an ejected shaping material and an ejection state of the ejected shaping material; and
a feedback processing step of executing a feedback process for controlling drive of the three-dimensional shaping apparatus based on a detection result detected in the detection step, wherein
in the feedback processing step,
the feedback process is executed under first control when a first portion of the stacked body is shaped,
the feedback process is executed under second control when a second portion that is different from the first portion of the stacked body is shaped, and
an execution frequency of the feedback process is made different between the first control and the second control.
